(19) United States
(12) Patent Application Publication
(10) Pub. No.: US 2006/0075732 A1
(43) Pub. Date: Apr. 13, 2006

(54) Weed and grass trimmer

(76) Inventors: John R. Nottingham, Bratenahl, OH (US); John W. Spirk, Gates Mills, OH (US); John W. Nottingham, Bratenahl, OH (US); Marc L. Vitantonio, South Russell, OH (US)

Correspondence Address: DKW LAW GROUP, P.C., 58TH FLOOR - USX TOWER, 600 GRANT STREET, PITTSBURGH, PA, 15219, US

(21) Appl. No.: 11/247,012

(22) Filed: Oct. 11, 2005

Related U.S. Application Data
(60) Provisional application No. 60/617,407, filed on Oct. 8, 2004.

(51) Int. Cl. A01D 34/00

(52) U.S. Cl. 56/12.7

(57) ABSTRACT

Disclosed is a battery-powered grass and weed trimming device including a housing portion with a handle portion and a shield portion. A first switch is disposed on a top side of the housing and a second switch is disposed on the bottom side of the housing. The second switch acts as a safety interlock to avoid accidental actuation of the device. A hub is disposed adjacent to the shield and retentively maintains a filament. A motor forcefully rotates the filament for cutting grass and weeds. The trimming device is packaged for sale in a sealed package having a feature that permits a prospective purchaser to momentarily operate the tirmmer while it is still in the package. The trimmer includes an optional wheeled extension handle to which the trimmer can be mounted to allow a user to use the trimmer while standing.

### CROSS-REFERENCE TO RELATED APPLICATIONS

This application claims the benefit of U.S. Provisional Patent Application Ser. No. 60/617,407, filed Oct. 8, 2004.

### BACKGROUND OF THE INVENTION

1. Field of the Invention

The present invention relates to a weed and grass trimmer, and more particularly, to a handheld, battery-powered weed and grass trimmer.

2. Description of Related Art

Power tools for trimming lawns and cutting weeds are well-known in the prior art. A variety of such tools includes cordless types of tools that operate on battery power. These tools are convenient for trimming and edging lawns, and for cutting weeds that grow near lawns, gardens, and other tended areas. Most such trimming tools have extended handles for use in the upright position. Others have combustion engines, while still others have electrical cord attachments. Existing grass and weed trimming power tools are not compact or lightweight enough to trim in very confined outdoor spaces, such as around shrubbery, walls, and poles. Further, with extended handles, existing devices are unwieldy for adjusting the angle at which the trimmer filament segment may be directed to the weeds or grass to be cut.

Further, existing battery-powered grass and weed trimmers utilize rechargeable, heavy-duty batteries for extended battery life. Because of the sheer weight and size of these trimmers, it has been heretofore impractical to use standard, non-rechargeable, general-purpose alkaline or similar dry cell batteries. These devices in the past have simply consumed more power than non-rechargeable alkaline batteries were capable of producing.

Hence, there exists a need for a compact, portable, handheld, battery-powered grass and weed trimming tool.

### SUMMARY OF THE INVENTION

The device of the present invention is a novel grass and weed trimming device. By reducing the size and corresponding power consumption of the device, it is practical to power the device using standard non-rechargeable, general purpose alkaline or similar dry cell batteries. Alkaline batteries are inexpensive and plentiful, and allow a sufficient operating life for the present invention.

The present invention is a grass and weed trimming device having a housing portion. The housing portion has a handle portion and a shield portion attached to the housing portion. There is a cavity disposed within the handle portion for housing a power source.

The device is controlled by two switches—a first switch disposed on the top side of the housing and a second switch disposed on the bottom side of the housing. The second switch acts as a safety interlock to avoid accidental actuation of the device. Preferably, first switch and second switch must be engaged in order to conduct power from the power source to energize a motor.

There is hub disposed adjacent to the shield having an aperture for retentively maintaining a filament section. The motor is electrically coupled to the power source by the switches for impelling the hub to forcefully rotate the filament section for cutting grass, weeds, and other similar material.

In one embodiment of the present invention, the filament segment has a shaped end, and the aperture is adapted for retentively receiving the shaped end to maintain the filament in position on the hub during operation of the device.

The handle portion of the housing is adapted to fit into a hollow cylindrical socket of an extension handle. The handle portion also has a jack input or other means to electrically link the shear to the handle for transferring the power switch control to the extension handle.

The present invention further provides a sealed package for the grass shear, which is packaged with batteries installed.

The device may be enclosed within a clamshell package with a protrusion adjacent to and applying pressure to the second switch such that the second switch remains engaged while contained within the package, with the first switch being operable through the surface of the package so that the device may be operated while contained therein.

In another embodiment, the package includes a transparent blister. The blister provides openings through which a purchaser can actuate both the first and second switches in order to turn the motor on and observe the operation of the shear in the package.

It is an object of the present invention to provide a compact, portable, handheld, and battery-powered or cordless tool for trimming grass, weeds, and the like. Another object of the present invention is to provide a safety feature comprised of a pair of switches that must be closed simultaneously in order to operate the device. Yet another object of the present invention is to provide a novel filament segment for cutting and a hub aperture for receiving said filament segment. A further object of the present invention is to provide a low-power tool that operates efficiently on non-rechargeable batteries, such as alkaline or similar general-purpose batteries.

### BRIEF DESCRIPTION OF THE DRAWINGS

FIG. 1 is a side elevational view of the novel grass and weed trimming device of the present invention;

FIG. 2 is a plan view of the trimming device;

FIG. 3 is a top plan view of the trimming device shown with a battery compartment detached from a housing;

FIG. 4 is an illustration of a filament segment attachment to a hub of the trimming device;

FIG. 5 is a sectional view illustration of the filament segment attachment to the hub shown in FIG. 4;

FIG. 6 is a bottom view of a shield showing the filament segment and hub;

FIG. 7 is a perspective view of the filament segment and hub;

FIG. 8 is a side elevational view of the trimming device being connected to an extension handle;

FIG. 9 is a top plan view of the trimming device in a sealed package designed to allow a potential purchaser to momentarily operate the shear in the package; and

FIG. 10 is a side elevational view of the trimming device in a sealed package, showing a cross section of the package, which is designed to allow a potential purchaser to momentarily operate the shear in the package.

### DETAILED DESCRIPTION OF THE INVENTION

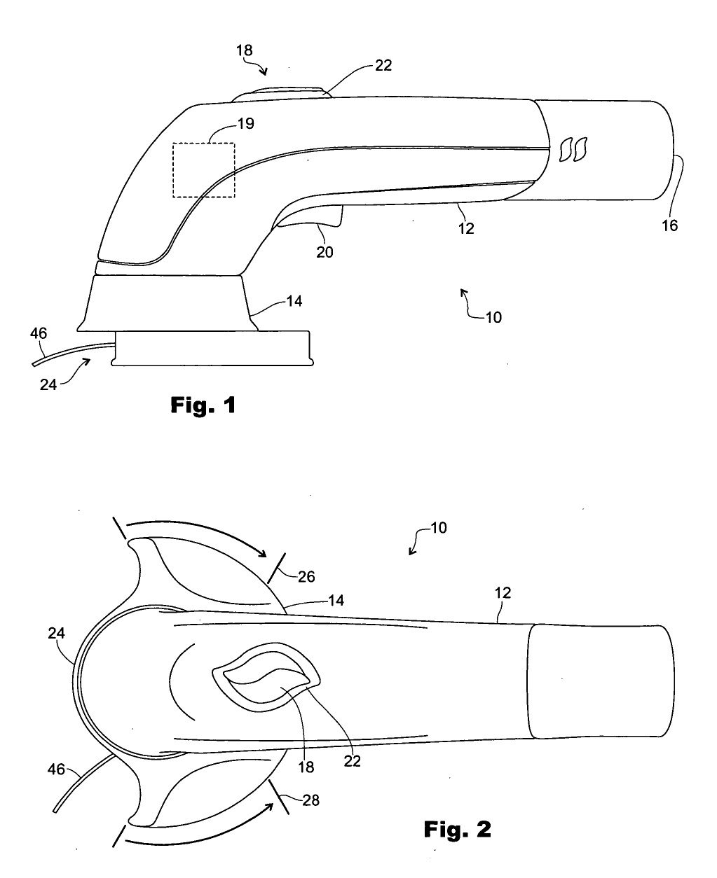

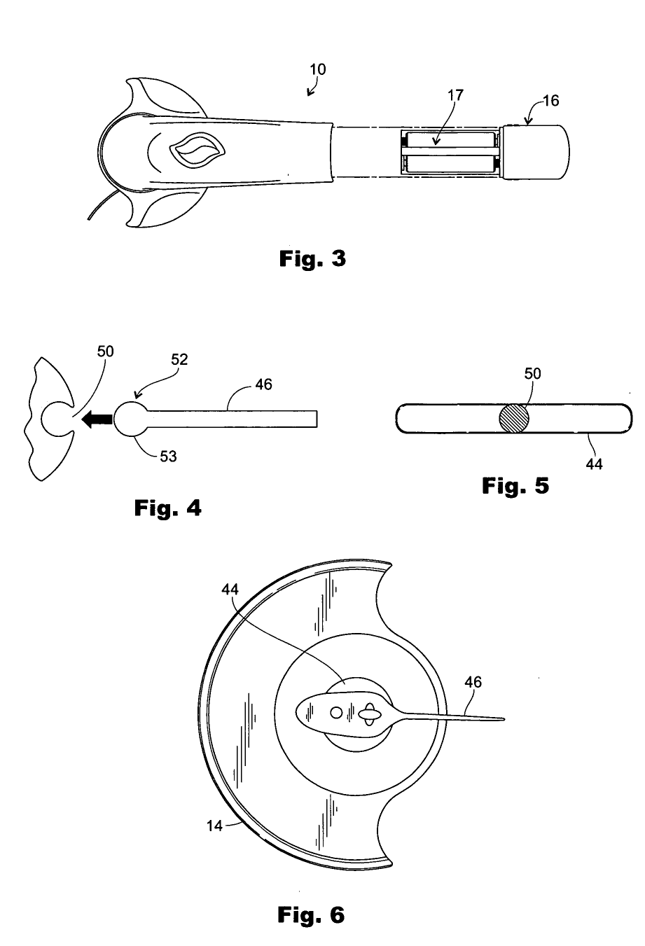

Referring, to FIGS. 1-3, a weed and grass trimmer is generally designated as 10. A hollow, curved housing 12 has a shield 14 attached at one end, which covers a trim filament 46 and a hub 44. Shield 14 partially covers the filament 46 and hub 44 to protect the user's hand when the trimmer 10 is operating.

At a butt end of housing 12 is a removable cap 16 for insertion of batteries 17 to power the trimmer 10. A push-button switch 18 is provided for energizing a small DC motor 19 from the batteries 17. A raised collar 22 is provided on the housing 12 surrounding push-button switch 18 to prevent accidental actuation. Also provided is a safety-interlock switch 20 located on the bottom of housing 12 opposite push-button switch 18. The trimmer 10 requires the operator to intentionally engage both push-button switch 18 and safety-interlock switch 20 in order to energize the motor 19, thus preventing inadvertent or accidental actuation of trimmer 10. In a preferred embodiment, safety-interlock switch 20 must be engaged first and must remain engaged during engagement of push-button switch 18. When push-button switch 18 is released, operation of the trimmer 10 ceases. Safety-interlock switch 20 also provides the ability to have a test or “try-me” feature while the trimmer 10 is in a package, so that a shopper may operate the trimmer 10 while it is still within the packaging in a store. This feature will be discussed in greater detail below.

A function of safety-interlock switch 20 is to avoid inadvertent actuation by, for example, placing the trimmer 10 on a surface with the push-button switch 18 side down. It would be possible for the push-button switch 18 to actuate the trimmer 10 alone, except for the requirement of engaging safety-interlock switch 20. Without safety-interlock switch 20, the trimmer 10 could accidentally run in the inverted position, due to the weight of the trimmer 10 pressing on the push-button switch 18. While collar 22 is designed to prevent, to some extent, that particular occurrence, if the surface upon which the trimmer 10 is inadvertently laid is irregular, collar 22 may not be effective in preventing accidental actuation. Thus, the position of safety-interlock switch 20 underneath opposite push-button switch 18 requires the user's thumb to operate push-button switch 18 and forefinger or other finger to grip the barrel of housing 12, so that the safety-interlock switch 20 is depressed simultaneously with push-button switch 18 in order to operate the trimmer 10.

Shield 14 has a partially-circular shape in the plan view, with a sector of the circle cut away 24, so as to expose a free end of the filament 46 to permit contact between the filament 46 and weeds or grass. Shield 14 may also optionally include a rotational feature, which allows the shield 14 to rotate partially or completely around the axis of the shield 14. If a partial rotation is used, it permits travel from one stop limit 26 to opposing stop limit 28, which enables the user to direct the cut away portion 24 to the side to which weeds or grass are to be cut.

It should be noted that a particular advantage of the disclosed embodiment is the use of disposable alkaline batteries 17 to power the small, DC motor 19 that drives the hub 44 that holds the filament 46. A variety of types of batteries 17 may be used, including general purpose alkaline and high-power lithium, and rechargeable batteries, such as nickel metal hydride or nickel cadmium batteries.

The filament 46, as shown in FIGS. 4-7, is attached to the hub 44 and rotates with hub 44, which is attached to the motor 19. While the trimmer 10 may operate with a spool of filament, as used in many commercially-available weed trimmers, the preferred embodiment discloses a single, precut length of plastic filament 46, rather than a continuous spool of filament, as the additional weight of the spool may adversely affect the battery life. The filament 46 may be comprised of a plastic, monofilament section having a shaped end 52. The filament 46 is a replaceable, wear item. The housing 12 may optionally include a cylindrical cavity for storage of spare filament 46 pieces.

Referring to FIGS. 4 and 5, in one embodiment, the shaped end 52 has a bulb 53 for mating with an insertion hole 50 in the hub 44. The bulb 53 is designed to prevent the centrifugal force of the motor from ejecting the filament 46 when it is attached to the hub 44. Hub 44 may include additional insertion hole 50 about its periphery for use of multiple filament sections 46, or for spare insertion hole 50 in the event one becomes plugged.

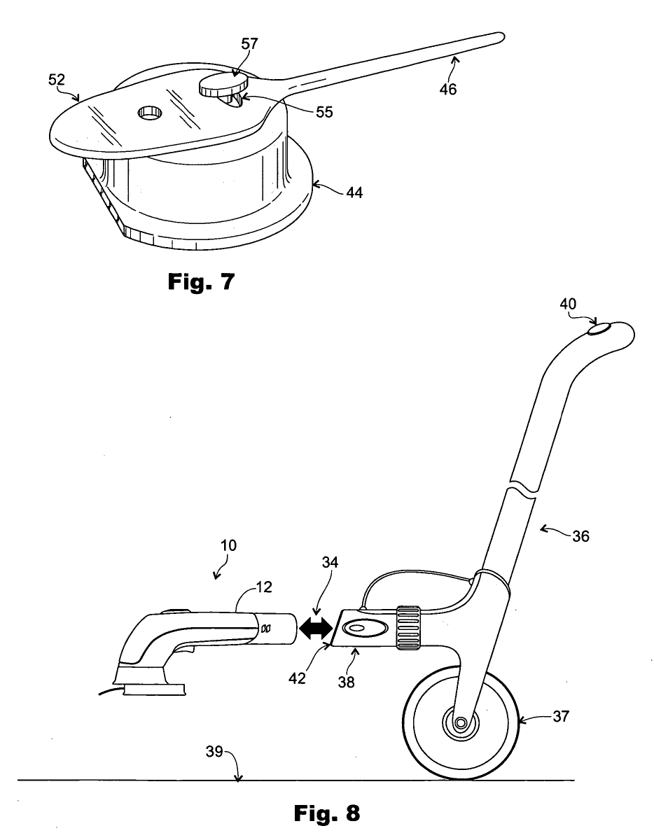

Referring to FIGS. 6 and 7, in another embodiment, the shaped end 52 includes a keyhole 55 configured to mate with a key 57 of the hub 44. The key 57 and keyhole 55 are designed to prevent the centrifugal force of the motor 19 from ejecting the filament 46 when it is attached to the hub 44.

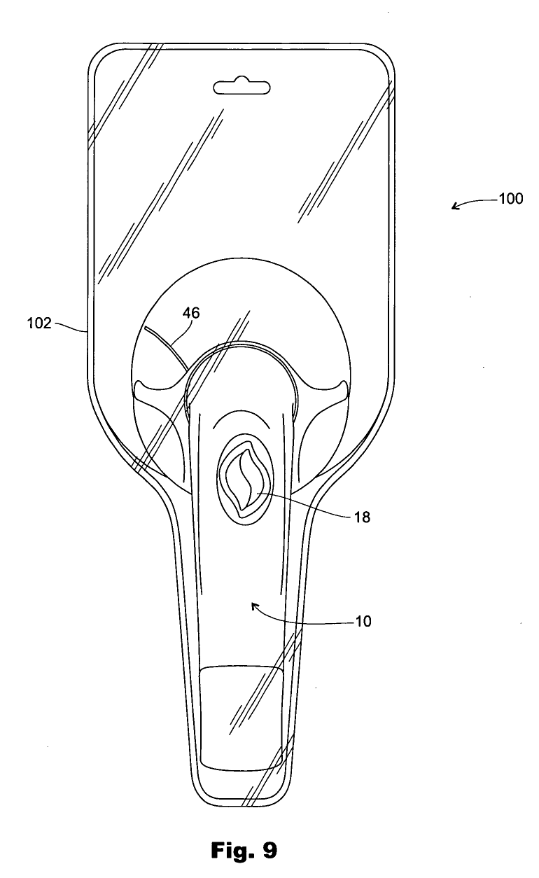

Referring next to FIG. 8, the weed and grass trimmer 10 is illustrated being inserted into an optional extension handle 36 so that the trimmer 10 may be used while a user is standing. Extension handle 36 has a socket 38 adapted to receive the cylindrical handle portion of housing 12. Arrow 34 indicates the lateral direction of insertion and removal of the trimmer 10. Socket 38 is appropriately sized for acceptance of a handle portion of housing 12 of the trimmer 10. A key-way may be provided to prevent rotation while the trimmer 10 is locked into the socket 38. A remote switch 40 at a top end of the extension handle 36 is interfaced with the weed trimmer 10 by way of plug 42 to transfer switch control to the opposite end of extension handle 36 when the trimmer 10 is placed into the extension handle 36. When the trimmer 10 is inserted into the extension handle 36, the safety-interlock switch 20 is engaged, so that the user can activate the motor 19 by pressing the remote switch 40 on the extension handle 36. A wheel 37 may extend from a bottom end of the extension handle 36 to assist in supporting the trimmer 10 on a surface 39.

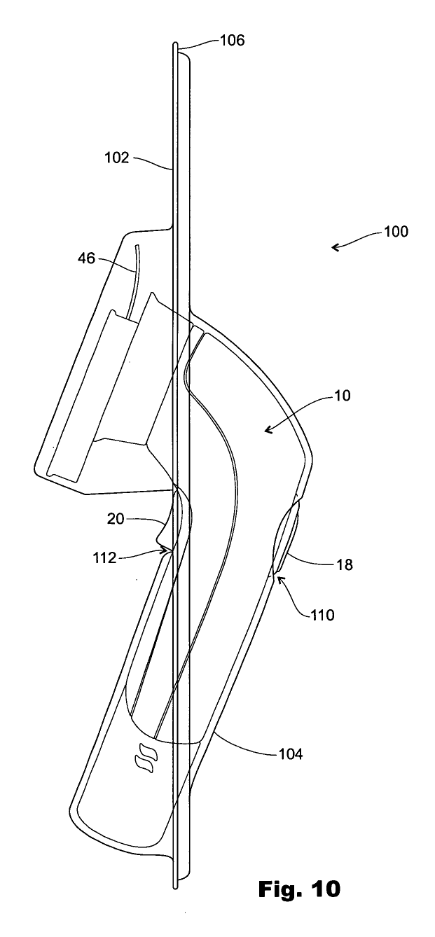

The safety-interlock switch 20 may be used to provide a test or “try me” feature while the trimmer 10 is inside a package 100. Referring to FIGS. 9 and 10, in one embodiment, the package 100 comprises a transparent front blister portion 104 and a transparent back blister portion 102. Front blister portion 104 and back blister portion 102 are manufactured using materials and methods well-known in the packaging art. Front and back blister portions 104, 102 are generally molded to conform to contours of the trimmer 10. Front and back blister portions 104, 102 have sidewalls dimensioned so that when the trimmer 10 is placed between the front and back blister portions 102, 104, the sidewalls are bonded by means known in the art to a generally flat outer perimeter flange-like portion 106 of package 100 such that the trimmer 10 is held securely within package 100 with minimal space to move. However, to facilitate the “try-me” feature, it is necessary that the part of package 100 containing the filament 46 be wide enough to accommodate the full range of motion of the filament 46. A push-button switch opening 110 is positioned in front blister portion 104 to align with push-button switch 50 to permit a potential purchaser to press and actuate push-button switch 50. A safety-interlock opening 112 is positioned in back blister portion 102 to align with safety-interlock switch 54 to permit a potential purchaser to press and actuate safety button 54.

In another embodiment (not shown), a clamshell package has a protrusion disposed so as to depress safety-interlocking switch and maintain the depressed position while the device is inside the packaging. The package allows a user to engage push-button switch in order to energize the motor, thereby causing the motor to turn the trim filament (or a paper representation of a filament) while enclosed in the packaging.

In another embodiment (not shown), the package comprises a backing card and a transparent blister portion. Backing card and blister portion are manufactured using materials and methods well-known in the packaging art. Blister portion is generally molded to conform to the top contours of the trimmer and has sidewalls dimensioned so that when the trimmer is placed into the blister portion, the backing card can be laid flat across the blister portion and bonded by means known in the art to a generally flat outer perimeter flange-like portion of blister portion such that the trimmer is held securely within blister portion with minimal space to move. However, to facilitate the “try-me” feature, it is necessary that the part of blister portion containing the filament (or representation of the filament) be wide enough to accommodate the full range of motion of the filament. The portion of blister portion over push-button switch must be pliable enough to permit a potential purchaser to press blister portion down far enough to actuate push-button switch. Ideally, blister portion is manufactured of a shape-retaining material that will spring back to its original contours after it has been pressed down to actuate push-button switch.

Since the trimmer is equipped with a safety-interlock switch that must be pressed in order to turn on the motor, a safety button block is enclosed in package between backing card and housing. Safety button block is preferably made of a relatively rigid, lightweight material, such as rigid plastic or foam, and is sized and shaped to fit securely between backing card and housing such that it holds the safety button in the depressed position while the trimmer is in package, thus allowing shoppers to turn on the motor by simply deforming the blister portion above push-button switch and pressing push-button switch. Once the trimmer is removed from the package, safety button block no longer presses against the safety interlock switch, and the trimmer is thus restored to full functionality.

This “Try Me” feature is useful in attracting purchasers to the product by allowing potential buyers to feel the way in which the trimmer 10 operates without having to remove the trimmer 10 from the retail packaging 100, thus encouraging buyers to purchase the trimmer 100. Those skilled in the art will appreciate that the blister packages described above are only potential embodiments of such a “try-me” package 100.

According to the provisions of the patent statutes, we have explained the principle, preferred construction, and mode of operation of the present invention, and have illustrated and described what we now consider to represent its best embodiments. However, it should be understood that within the scope of the appended claims and the foregoing description, the present invention may be practiced otherwise than as specifically illustrated and described.

What is claimed is:

1. A grass and weed trimming device, comprising:
a housing portion having a handle portion;
a shield portion attached to said housing portion at an end opposite said handle portion;
a cavity disposed within said handle portion for housing a power source;
a first switch disposed on a top side of said housing;
a second switch disposed on a bottom side of said housing;
a hub having an aperture for retentively maintaining a filament section; and
a motor electrically coupled to said power source via said first switch and said second switch for impelling said hub to forcefully rotate said filament section for cutting grass or weeds,
wherein said first switch and said second switch must be engaged in order to conduct power from the power source to energize the motor.

2. The grass and weed trimming device of claim 1, wherein said filament section has a shaped end, and said aperture is adapted for retentively receiving said shaped end to maintain said filament in position during operation of the device.

3. The grass and weed trimming device of claim 2, wherein said shaped end is a bulb.

4. The grass and weed trimming device of claim 2, wherein:
said shaped end includes a keyhole, and
said hub includes a key configured to engage said keyhole.

5. The grass and weed trimming device of claim 1, wherein said handle portion is adapted to fit into a hollow cylindrical socket for attachment to an extension handle.

6. The grass and weed trimming device of claim 5, wherein said handle portion also having a jack input for transferring switch control to an extension handle.

7. The grass and weed trimming device of claim 1, further including a blister package including a first switch opening aligned with said first switch and a second switch opening aligned with said second switch, wherein said user can actuate the second switch through the second switch opening and said user can actuate the first switch through the first switch opening.

8. A method of using an electric trimmer, comprising the steps of:
activating a safety button; and
subsequently activating a power switch while the safety button is activated to allow operation of the trimmer.

9. The method of claim 8, further including the steps of:
attaching a wheeled extension handle to the trimmer, wherein the wheeled extension handle is electrically connected to the trimmer; and
supporting a wheel of the wheeled extension handle on a surface.

10. A trimmer, comprising:
a housing including a handle portion and a motor housing portion;
a motor contained within said motor housing portion;
a power supply in electrical communication with said motor;
a power switch configured to control a flow of electric power from said power supply to said motor;
a hub extending from said housing;
a filament section retentively maintained on said hub; and
a safety button linked to the power switch such that said safety button must be actuated before said power switch can be actuated to allow said flow of electric power from said power supply to said motor,
wherein said motor causes said hub to rotate said filament section.

11. The trimmer of claim 10, wherein the power supply is batteries.

12. The trimmer of claim 11, wherein:
said housing includes a handle portion, and
said handle portion includes a battery compartment, wherein said battery compartment houses said batteries.

13. The trimmer of claim 10, wherein said trimmer is packaged in a sealed package having a feature that permits a user to momentarily operate the trimmer while it is still in the package.

14. The trimmer of claim 13, further including a power switch opening aligned with said power switch and a safety button opening aligned with said safety button, wherein said user can actuate the safety button through the safety button opening and said user can actuate the power switch through the power switch opening.

15. The trimmer of claim 10, wherein said housing further comprises a raised collar around said power switch.

16. The trimmer of claim 10, further including:
an extension handle having a top end and a bottom end;
a wheel extending from said bottom end;
an electrical switch positioned at said top end and in electrical communication with said motor; and
a coupling configured to removably attach said trimmer to said extension handle,
wherein activation of said electrical switch controls said flow of electric power from said power supply to said motor, and
said trimmer is supportable on a surface via said wheel.

17. The trimmer of claim 10, wherein said safety button must remain actuated during actuation of said power switch to maintain said flow of electric power from said power supply to said motor.

18. The trimmer of claim 10, wherein said power switch is positioned on a top side of said housing, and said safety button is positioned on a bottom side of said housing.
